(19) United States
(12) Patent Application Publication
(10) Pub. No.: US 2009/0297838 A1
(43) Pub. Date: Dec. 3, 2009

(54) Ultraviolet solar simulation filter device and method of manufacture

(75) Inventor: Jamie Knapp, Mendon, MA (US)

Correspondence Address: NEWPORT CORPORATION, 1791 DEERE AVENUE, IRVINE, CA, 92606, US

(73) Assignee: Newport Corporation, Irvine, CA (US)

(21) Appl. No.: 12/156,559

(22) Filed: Jun. 2, 2008

(51) Int. Cl. B32B 17/06

(52) U.S. Cl. 428/336; 428/432

(57) ABSTRACT

Various embodiments of UV solar simulation devices are disclosed herein. In one embodiment, the present application discloses an ultraviolet solar simulator filter device comprising an optically transparent substrate configured to be supported within a solar simulator, a first layer of Tantalum Pentoxide applied to at least one surface of the substrate, and at least a second layer of Silica Oxide applied to the first layer. Optionally, the substrate may comprise a rigid or flexible structure. Further, any variety of thickness of materials may be used to form the first and second layers. For example, in one embodiment, the first and second layers have a thickness of about 30 nm to about 70 nm each.

### CROSS-REFERENCE TO RELATED APPLICATIONS

The present application claims priority to U.S. Provisional Patent Application Ser. No. 60/933,203, filed Jun. 4, 2007, the entire contents of which are hereby incorporated by reference in its entirety herein

### BACKGROUND

Presently, solar simulation devices are used in a variety of applications to reliably create artificial light which mimics the spectral output of the sun. For example, these devices are often used for testing photovoltaic cells and devices, testing the effectiveness of sunscreens or cosmetics, as well as a myriad of other applications. Typically, three discreet UV wavelength bands are defined within this spectral range: UV-A (320 nm-400 nm), UV-B (290 nm-320 nm), and UV-C (100nm-290 nm).

Currently, instruments used for producing or detecting the UV portion of the solar spectrum include traditional colored glasses configured to transmit the UV-A and UV-B portion of the UV spectrum, while not transmitting the UV-C band or most of the visible spectrum (i.e. 400 nm-650 nm). Examples of colored glass used to produce these UV filters include Schott UG-11 and Hoya U340. FIG. 1 shows the wavelength dependent transmittance of a colored glass UV filter presently available. While devices produced using these color glass materials have proven somewhat useful in the past, a number of shortcomings have been identified. For example, filters manufactured from these materials are very fragile and sensitive to environmental stresses. Further, in some applications, these devices also exhibit inadequate transmittance in the UV-A and UV-B range, while offering insufficient rejection of the UV-C band. Also, the performance of these filters may degrade over time as a result of solarization. Additionally, the thickness of these filters (typically greater than 3 mm) and size of the available filters (typically less than 6.5 inches) further limits the usefulness of these devices. Lastly, devices manufactured from these materials are expensive.

Thus, in light of the foregoing, there is an ongoing need for cost effective filters having improved durability over existing devices and providing very high transmittance of UV-A and UV-B spectral bands, while having very little transmittance of the UV-C or visible light spectral bands.

### SUMMARY

Various embodiments of UV solar simulation devices are disclosed herein. In one embodiment, the present application discloses an ultraviolet solar simulator filter device comprising an optically transparent substrate configured to be supported within a solar simulator, a first layer of Tantalum Pentoxide applied to at least one surface of the substrate, and at least a second layer of Silica Oxide applied to the first layer. Optionally, the substrate may comprise a rigid or flexible structure. Further, any variety of thickness of materials may be used to form the first and second layers. For example, in one embodiment, the first and second layers have a thickness of about 30 nm to about 70 nm each.

In another embodiment, the present application is directed to a UV solar simulation filter device and includes an optically transparent substrate configured to be supported within a solar simulator, a first layer of Tantalum Pentoxide applied to at least one surface of the substrate, and at least a second layer of Silica Oxide applied to at least one surface of the substrate. IN one embodiment, the second layer is applied to the first layer.

Other features and advantages of the embodiments of the UV solar simulation devices as disclosed herein will become apparent from a consideration of the following detailed description.

### BRIEF DESCRIPTION OF THE DRAWINGS

Various UV solar simulation devices will be explained in more detail by way of the accompanying drawings, wherein

FIG. 1 shows an graphically the wavelength dependent transmittance of a standard colored glass filter;

FIG. 2 shows a side view of an embodiment of a UV solar simulation filter device as having a first and second layer applied to a substrate;

FIG. 3 shows a side view of an embodiment of a UV solar simulation filter device as having alternating layers of coating materials applied to a substrate;

FIG. 4 shows a side view of an embodiment of a UV solar simulation filter device as having alternating layers of coating materials and at least one additional layer applied to the substrate; and

FIG. 5 shows graphically the wavelength dependent transmittance of an embodiment of a UV solar simulation filter device disclosed herein.

### DETAILED DESCRIPTION

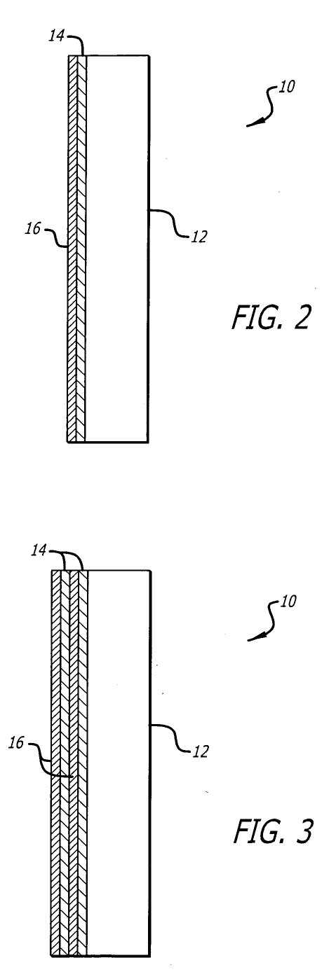

FIG. 2 shows a cross-sectional view of an embodiment of an ultraviolet solar simulator filter. As shown in FIG. 2, the ultraviolet (hereinafter UV) solar simulator filter 10 comprises at least one substrate 12 having a first layer 14 and at least a second layer 16 of coating material applied thereto. In one embodiment, the substrate 12 comprises a rigid structure. Optionally, the substrate 12 may comprise a flexible structure or membrane. In the illustrated embodiment, the substrate 12 comprises silica glass. More specifically, in one embodiment the substrate 12 comprises synthetic fused silica or borosilicate-type glass configured to receive at least one optical coating applied thereto. Optionally, any variety of other substrate materials may be used including, without limitation, glass, silicon, composite materials, ceramics, metals, membrane, aerogels, mylar, polymer substrates, semiconductor devices and substrates, optical windows, and the like. Further, the substrate 12 may be manufactured in any variety of sizes, thicknesses, and/or shapes.

Referring again to FIG. 2, the first layer 14 of coating material may be applied to at least one surface of the substrate 12 using any variety of techniques know in the art. For example, in one embodiment, a first layer 14 of coating material may be applied to a surface of the substrate 12 using plasma-enhanced sputtering or ion plating coating techniques known in the art. Optionally, any variety of alternate coating processes may be used to apply the first layer 14 to the substrate 12. For example, U.S. Pat. No. 6,139,968, the entirely of which is incorporated by reference herein, discloses an embodiment of an ion plating apparatus which may be used for applying at least one layer of coating material to the substrate. Optionally, any variety of alternate coating techniques may be used to apply at least one layer of coating material to the substrate 12, including, without limitation, physical vapor deposition, magnetron sputtering, ion beam sputtering, ion-assisted electron beam deposition, chemical vapor deposition, ion plating, and the like.

As shown in FIG. 2, the first layer 14 of coating material may comprise Tantalum Pentoxide (Ta₂O₅), although those skilled in the art will appreciate that any variety of alternate materials may be used. In one embodiment, the first layer 14 has a thickness of about 57 nm, although those skilled in the art will appreciate that the first layer 14 and second layer 16 may have any thickness. At least a second layer 16 of coating material may applied to the substrate 12. In the illustrate embodiment, the second layer 16 is applied to the first layer 14 of coating material. Optionally, the second layer 16 of coating material may be applied to any surface of the substrate 12. Like the first layer 14, the second layer 16 may be applied to the substrate using any variety of coating techniques known in the art, including, without limitation, physical vapor deposition, magnetron sputtering, ion beam sputtering, ion-assisted electron beam deposition, chemical vapor deposition, ion plating, and the like. In the illustrated embodiment, the second layer 14 comprises silicon dioxide (SiO₂), although those skilled in the art will appreciate that any variety of materials could be used to form the second layer 16. In one embodiment, the thickness of the second layer 16 may have a thickness of about 48 nm.

Referring again to FIG. 2, in the illustrated embodiment the substrate 12 comprises silica glass, the first layer 14 comprises Tantalum Pentoxide, and the second layer 16 comprises Silicon Dioxide. As such, the cost of manufacturing the UV solar simulator filter 10 is considerably less expensive than comparable colored glass-based UV solar filters presently available. Further, the UV solar simulator 10 may be manufactured in any variety of sizes and thicknesses. In addition, the UV solar simulator filter 10 disclosed herein may be produced in considerably less time (approx. 10 hrs) as compared with devices produced with standard deposition methods, materials and designs (approx. 50 hrs). The UV solar simulator filters disclosed herein are more durable and are less subject to solarization than presently available colored glass devices,

FIG. 3 shows an alternate embodiment of a UV solar simulator filter. Like the previous embodiment, the solar simulator 10 comprises a substrate 12 having a first layer 14 and at least a second layer 16 of coating material applied thereto. In the illustrate embodiment, alternating first layers 14 and second layers 16 of coating materials are applied to the substrate 12. Any number of alternating layers of first and second layers 14, 16, respectively, may be applied to the substrate 12. More specifically, a first layer 14 of the comprise Tantalum Pentoxide while the second layers 16 comprise Silicon Dioxide. For example, in one embodiment 66 alternate layers of Tantalum Pentoxide and Silicon Dioxide may be applied to the substrate 12. Optionally, any variety of materials may be used to form the first layer 14, the second layer 16, or both. Like the previous embodiment, the first and second layers 14, 16 may be applied using any variety of coating processes, including, without limitation, physical vapor deposition, magnetron sputtering, ion beam sputtering, ion-assisted electron beam deposition, chemical vapor deposition, ion plating, and the like. Those skilled in the art will appreciate that any number of alternating first and second layers 14, 16 may be applied to substrate 12.

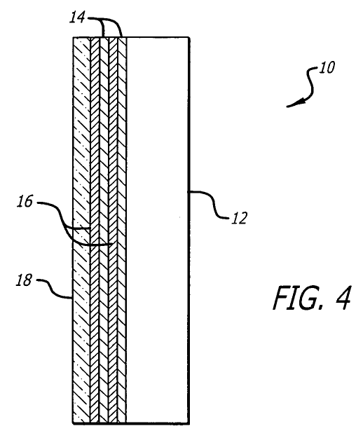

FIG. 4 shows an alternate embodiment of a UV solar simulator filter. Like the previous embodiment, the solar simulator 10 comprises a substrate 12 having a first layer 14 and at least a second layer 16 of coating material applied thereto. In the illustrate embodiment, alternating first layers 14 and second layers 16 of coating materials are applied to the substrate 12. More specifically, a first layer 14 may comprise Tantalum Pentoxide while the second layers 16 comprise Silicon Dioxide. Optionally, any variety of materials may be used to form the first later 14, the second layer 16, or both The substrate 12 may have a thickness of about 1 mm to about 5 mm, the first layer 14 has a thickness of about 30 nm to about 70 nm, and the second layer 16 has a thickness of about 40 nm to about 65 nm. Exemplary alternate materials include, without limitation, Hafnium (HfO₂) or Zirconium Oxide (ZrO₂). For example, the table below shows the physical characteristics of the coatings forming an embodiment of a solar simulation filter device:
AIR/GLASS/1.51052H 0.78976L (0.6546L 1.26172H 0.61496L) 10 times 0.78148L 1.29676H 0.62708L (0.7696L 1.43088H 0.76888L) 7 times 0.84988L 1.54884H 0.79464L (0.8704L 1.66572H 0.87596L) 12 times 0.84144L 1.55324H 0.83212L/AIR

Where:

1H=1 OPTICAL QUARTER WAVE OF Ta₂O₅ AT 353 nm

1L=1 OPTICAL QUARTER WAVE OF SiO₂ AT 353 nm.

Like the previous embodiment, the first and second layers 14, 16 may be applied using any variety of coating processes, without limitation, physical vapor deposition, magnetron sputtering, ion beam sputtering, ion-assisted electron beam deposition, chemical vapor deposition, ion plating, and the like. In addition, one or more addition layers 18 may be applied to the UV solar simulator filter 10. For example, layer 18 may comprise a protective overcoating configured to protect the UV solar simulator 10 from environmental damage. Any variety of materials may be used to form the additional layer 18, including, without limitation, SiO₂, Ta₂O₅, HfO₂ or ZrO₂.

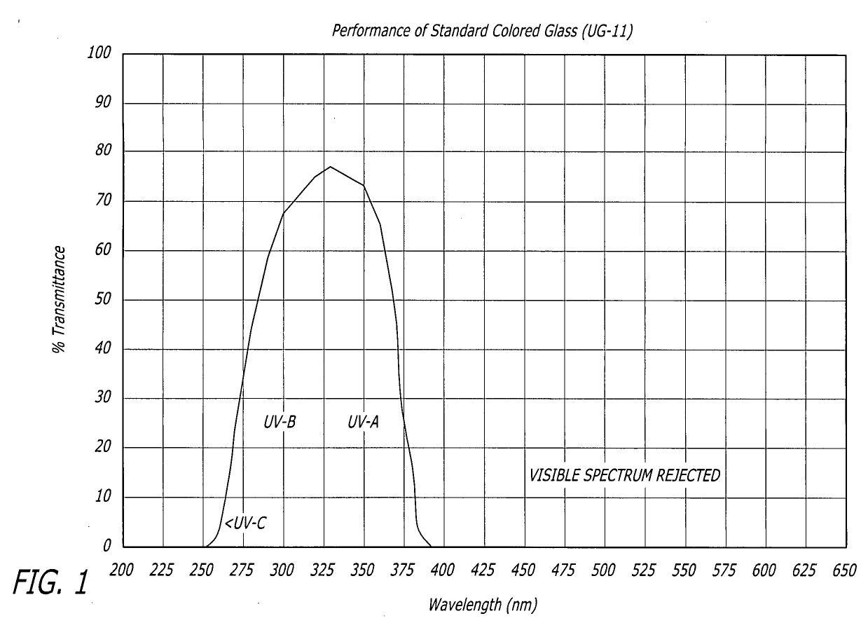

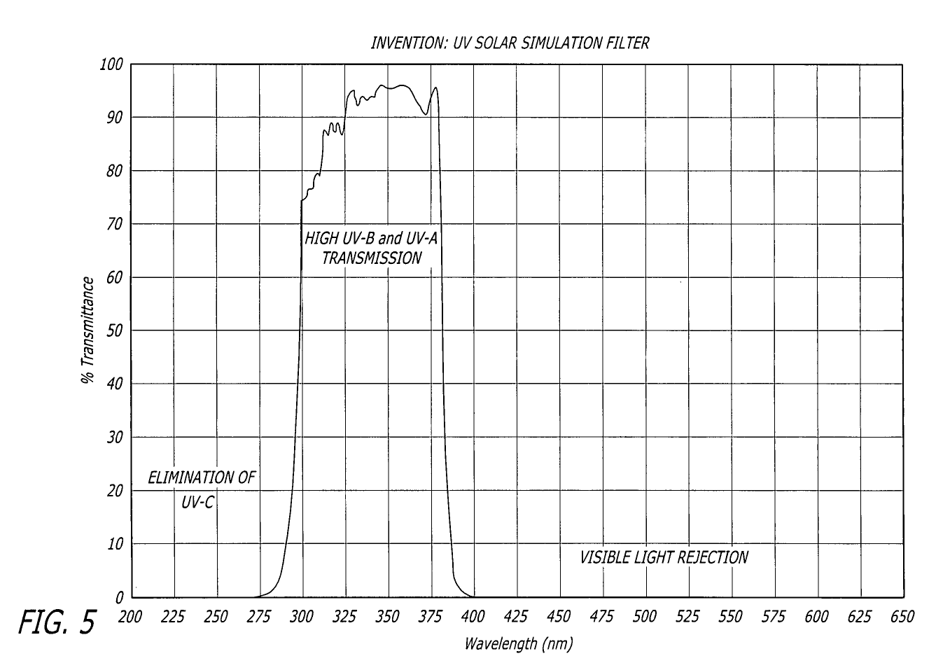

FIG. 5 and Table 1 show the wavelength dependent transmittance of an embodiment of UV solar simulator filter and a colored glass filter presently available. As shown, the UV solar simulator filter offer improved transmission of UV-A and UV-B light as compared with the presently available colored glass filters (as shown in FIG. 1). Further, the UV solar simulator filter transmitted considerably less undesirable UV-C and visible light.

TABLE 1

| TECHNOLOGY | UV-C | UV-B and UV-A | VISIBLE |
|---|---|---|---|
| Present Available | 5.5% AVG | 68% AVG | <0.1% AVG |
| Colored Glass | 200 nm-280 nm | 300 nm-375 nm | 400 nm-635 |
| Technology | | | nm |
| Novel UV Solar | .006% AVG | 89% AVG | <0.1% AVG |
| Simulator Filter | 200 nm-280 nm | 300 nm-375 nm | 400 nm-635 |
| | | | nm |

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed is:

1. An ultraviolet solar simulator filter device, comprising:
an optically transparent substrate configured to be supported within a solar simulator;
a first layer of Tantalum Pentoxide applied to at least one surface of the substrate; and
at least a second layer of Silica Oxide applied to the first layer.

2. The device of claim 1 wherein the substrate comprises a rigid structure.

3. The device of claim 1 wherein the substrate comprises a flexible substrate.

4. The device of claim 1 wherein the substrate comprises silica glass.

5. The device of claim 1 wherein the substrate is selected from the list consisting of glass, silicon, composite materials, ceramics, metals, membrane, aerogels, mylar, polymer substrates, semiconductor devices and substrates, and optical windows

6. The device of claim 1 wherein the filter device further comprises multiple alternating layers of Tantalum Pentoxide and Silica Oxide.

7. The device of claim 1 wherein the first layer has a thickness of about 30 nm to about 70 nm.

8. The device of claim 1 wherein the second layer has a thickness of about 40 nm to about 65 nm.

9. The device of claim 1 wherein at least one of the first and second layers is applied to the substrate using a plasma-sputtering process.

10. The device of claim 1 wherein at least one of the first and second layers is applied to the substrate using an ion plating coating process.

11. The device of claim 1 wherein at least one of the first and second layers is applied to the substrate using at least one coating process selected from the group consisting of physical vapor deposition, magnetron sputtering, ion beam sputtering, ion-assisted electron beam deposition, chemical vapor deposition, and ion plating.

12. The device of claim 1 further comprising at least one additional layer applied to at least one of the first layer, the second layer, and the substrate.

13. The device of claim 12 wherein the additional layer comprises a protective overcoat manufactured from a material selected from the group consisting of SiO₂, Ta₂O₅, HfO₂, and ZrO₂.

14. An ultraviolet solar simulator filter device, comprising:
an optically transparent substrate configured to be supported within a solar simulator;
a first layer of Tantalum Pentoxide applied to at least one surface of the substrate; and
at least a second layer of Silica Oxide applied to at least one surface of the substrate.

15. The device of claim 14 wherein the substrate comprises silica glass.

16. The device of claim 14 wherein the second layer is applied to the first layer.

17. The device of claim 16 wherein the filter further comprises multiple alternating layers of Tantalum Pentoxide and Silica Oxide.

18. The device of claim 17 wherein the first layer has a thickness of about 30 nm to about 70 nm.

19. The device of claim 18 wherein the second layer has a thickness of about 40 nm to about 65 nm.

20. The device of claim 12 wherein the additional layer comprises a protective overcoat manufactured from a material selected from the group consisting of SiO₂, Ta₂O₅, HfO₂, and ZrO₂.
